(19) United States
(12) Patent Application Publication
(10) Pub. No.: US 2007/0230608 A1
(43) Pub. Date: Oct. 4, 2007

(54) Method and apparatus for quasi maximum likelihood MIMO detection

(76) Inventor: Guangjie Li, Beijing (CN)

Correspondence Address: KACVINSKY LLC;C/O INTELLEVATE, P.O. BOX 52050, MINNEAPOLIS, MN, 55402, US

(21) Appl. No.: 11/394,922

(22) Filed: Mar. 31, 2006

(51) Int. Cl. H04L 1/02

(52) U.S. Cl. 375/267

(57) ABSTRACT

Techniques for MIMO detection that has performance approaching that of a maximum likelihood (ML) algorithm while having a reduced computational complexity are described. One method of an embodiment decomposes a MIMO channel into a 2×2 system. QR decomposition and maximum likelihood detection may be performed on the 2×2 system. Thereafter, certain metrics are combined and either a soft demodulation or decision and cancellation follows. Other embodiments are described and claimed.

### BACKGROUND

Modern wireless communication systems may operate according to standards such as the Institute of Electrical and Electronics Engineers (IEEE) 802.11 standards for Wireless Local Area Networks (WLANs), the IEEE 802.16 standards for Wireless Metropolitan Area Networks (WMANs), and the 3^{rd} Generation Partnership Project for Long Term Evolution of wireless networks (3GPP LTE) standards. Worldwide Interoperability for Microwave Access (WiMAX) is a wireless broadband technology based on the IEEE 802.16 standard of which IEEE 802.16-2004 and the 802.16e amendment are Physical (PHY) layer specifications.

Wireless communications systems, for example those operating to the IEEE 802.11, IEEE 802.16, and 3GGP LTE standards, may implement multiple input multiple output (MIMO) technology to increase the data rate of the wireless service. MIMO technology allows spatial multiplexing of data streams from one or multiple users. The performance and complexity of MIMO systems depends largely on the number of antennas used. In practice, it is a significant challenge to support high data rates and large numbers of antennas there is a need, therefore, to develop highly efficient architectures for realization of different signal processing algorithms in MIMO systems having a large number of antenna elements.

### BRIEF DESCRIPTION OF THE DRAWINGS

FIG. 1 illustrates a wireless system.

FIG. 2 illustrates a wireless system node.

FIG. 3 illustrates the performance of MIMO detection techniques.

FIG. 4 illustrates the complexity of MIMO detection techniques.

FIG. 5 illustrates the performance of a MIMO detection technique of an embodiment.

FIG. 6 illustrates a block diagram of a MIMO detector of an embodiment.

FIG. 7 illustrates a block diagram of a portion of a MIMO detector of an embodiment.

FIG. 8 illustrates detail of the block diagram of FIG. 7.

FIG. 9 illustrates a logic flow of an embodiment.

### DETAILED DESCRIPTION

Embodiments of a method and apparatus for quasi maximum likelihood MIMO detection will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Various embodiments are generally directed to techniques for MIMO detection that have performance approaching that of a maximum likelihood (ML) algorithm while having a reduced computational complexity. The method of an embodiment decomposes a MIMO channel with M transmitter antennas and N receiver antennas (an N×M MIMO system) into a 2×2 MIMO system. QR decomposition and maximum likelihood detection may be performed on the 2×2 MIMO system. Thereafter, certain metrics are combined and either a soft demodulation or decision and cancellation follows.

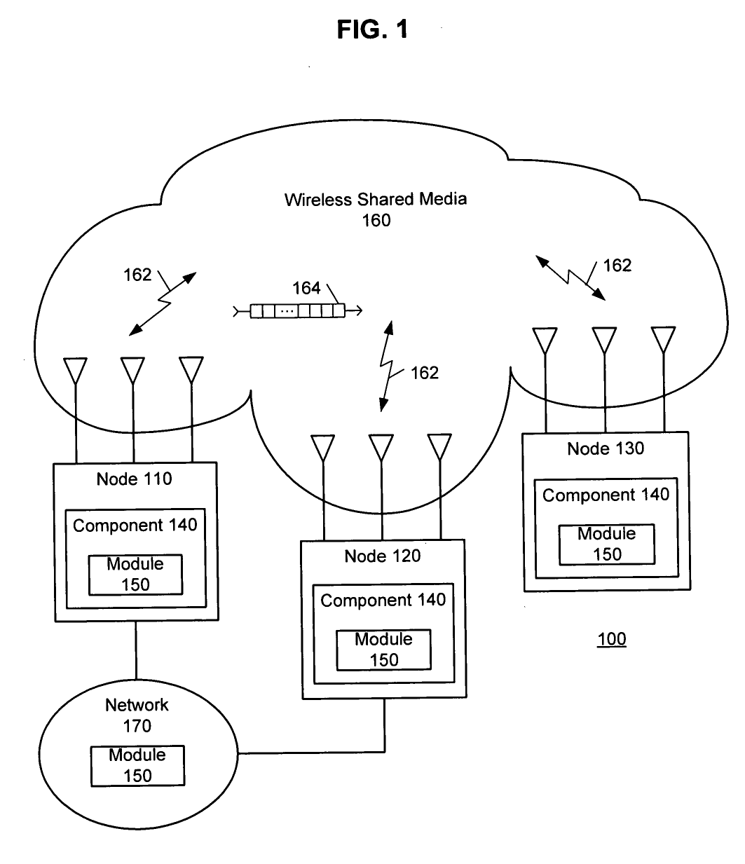

FIG. 1 illustrates an embodiment of a system. FIG. 1 illustrates a block diagram of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various implementations, the nodes of the communications system 100 may be arranged to segment a set of media information and control information into a series of packets. A packet generally may comprise a discrete data set having fixed or varying lengths, and may be represented in terms of bits or bytes. It can be appreciated that the described embodiments are applicable to any type of communication content or format, such as packets, cells, frames, fragments, units, and so forth.

The communications system 100 may communicate information in accordance with one or more standards, such as standards promulgated by the IEEE, the Internet Engineering Task Force (IETF), the International Telecommunications Union (ITU), the 3GPP and so forth. In various embodiments, for example, the communications system 100 may communicate information according to one or more IEEE 802 standards including IEEE 802.11 standards (e.g., 802.11a, b, g/h, j, n, and variants) for WLANs and/or 802.16 standards (e.g., 802.16-2004, 802.16.2-2004, 802.16e, 802.16f, and variants) for WMANs, and/or 3GPP LTE standards. The communications system 100 may communicate information according to one or more of the Digital Video Broadcasting Terrestrial (DVB-T) broadcasting standard and the High performance radio Local Area Network (HiperLAN) standard. The embodiments are not limited in this context.

In various embodiments, the communications system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The communications system 100 may include one or more nodes (e.g., nodes 110-130) arranged to communicate information over one or more wired and/or wireless communications media. Examples of wired communications media may include a wire, cable, printed circuit board (PCB), backplane, switch fabric, semiconductor material, twisted-pair wire, co-axial cable, fiber optics, and so forth. An example of a wireless communication media may include portions of a wireless spectrum, such as the radio-frequency (RF) spectrum. In such implementations, the nodes of the system 100 may include components and interfaces suitable for communicating information signals over the designated wireless spectrum, such as one or more transmitters, receivers, transceivers, amplifiers, filters, control logic, antennas and so forth.

The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth.

In various embodiments, the communications system 100 may comprise or form part of a network, such as a WiMAX network, a broadband wireless access (BWA) network, a WLAN, a WMAN, a wireless wide area network (WWAN), a wireless personal area network (WPAN), a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, a local area network (LAN), a wide area network (WAN), a metropolitan area network (MAN), the Internet, the World Wide Web, a cellular network, a radio network, a satellite network, and/or any other communications network configured to carry data. The embodiments are not limited in this context.

The communications system 100 may employ various modulation techniques including, for example: OFDM modulation, Quadrature Amplitude Modulation (QAM), N-state QAM (N-QAM) such as 16-QAM (four bits per symbol), 32-QAM (five bits per symbol), 64-QAM (six bits per symbol), 128-QAM (seven bits per symbol), and 256-QAM (eight bits per symbol), Differential QAM (DQAM), Binary Phase Shift Keying (BPSK) modulation, Quadrature Phase Shift Keying (QPSK) modulation, Offset QPSK (OQPSK) modulation, Differential QPSK (DQPSK), Frequency Shift Keying (FSK) modulation, Minimum Shift Keying (MSK) modulation, Gaussian MSK (GMSK) modulation, and so forth. The embodiments are not limited in this context.

The communications system 100 may form part of a multi-carrier system such as a MIMO system. The MIMO system may employ one or more multi-carrier communications channels for communicating multi-carrier communication signals. A multi-carrier channel may comprise, for example, a wideband channel comprising multiple sub-channels. The MIMO system may be arranged to communicate one or more spatial data streams using multiple antennas. Examples of an antenna include an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the communications system 100 may be arranged to detect a MIMO system. More specifically, the communications system 100 may be arranged to detect a MIMO system with a method that approaches maximum likelihood (ML) performance with reduced computational complexity. In an embodiment, the received MIMO signal may be decomposed with QR decomposition after which the decomposed received signal may undergo ML detection. As the ML detection is applied to multiple smaller decomposed matrices, the complexity of the ML detection may be reduced. In an embodiment, a soft output may be thereafter calculated and may aid the performance in particular with iterative coding schemes. In an alternate embodiment, the result of the ML detection may undergo a decision and cancellation process.

In one embodiment, communications system 100 may include one or more wireless communication devices, such as nodes 110-130. Nodes 110-130 all may be arranged to communicate information signals using one or more wireless transmitters/receivers (“transceivers”) or radios, which may involve the use of radio frequency communication via 802.11 schemes, 802.16 schemes (e.g., 802.16-2004, 802.16.2-2004, 802.16e, 802.16f, and variants), and 3GGP (e.g., 3GGP LTE) for example. Nodes 110-130 may communicate using the radios over wireless shared media 160 via multiple links or channels established therein. Although FIG. 1 is shown with a limited number of nodes in a certain topology, it may be appreciated that communications system 100 may include additional or fewer nodes in any type of topology as desired for a given implementation. The embodiments are not limited in this context.

Further, nodes 110 and 120 may comprise fixed devices having wireless capabilities. A fixed device may comprise a generalized equipment set providing connectivity, management, and control of another device, such as mobile devices. Examples for nodes 110 and 120 may include a wireless access point (AP), base station or node B, router, switch, hub, gateway, media gateway, and so forth. In an embodiment, nodes 110 and 120 may also provide access to a network 170 via wired communications media. Network 170 may comprise, for example, a packet network such as the Internet, a corporate or enterprise network, a voice network such as the Public Switched Telephone Network (PSTN), among other WANs, for example. The embodiments are not limited in this context.

In one embodiment, system 100 may include node 130. Node 130 may comprise, for example, a mobile device or a fixed device having wireless capabilities. A mobile device may comprise a generalized equipment set providing connectivity to other wireless devices, such as other mobile devices or fixed devices. Examples for node 130 may include a computer, server, workstation, notebook computer, handheld computer, telephone, cellular telephone, personal digital assistant (PDA), combination cellular telephone and PDA, and so forth.

Nodes 110-130 may have one or more wireless transceivers and wireless antennas. In one embodiment, for example, nodes 110-130 may each have multiple transceivers and multiple antennas (e.g., a MIMO system) to communicate information signals over wireless shared media 160. For example, a channel 162, link, or connection may be formed using one or more frequency bands of wireless shared medium 160 for transmitting and receiving packets 164. The embodiments are not limited in this context.

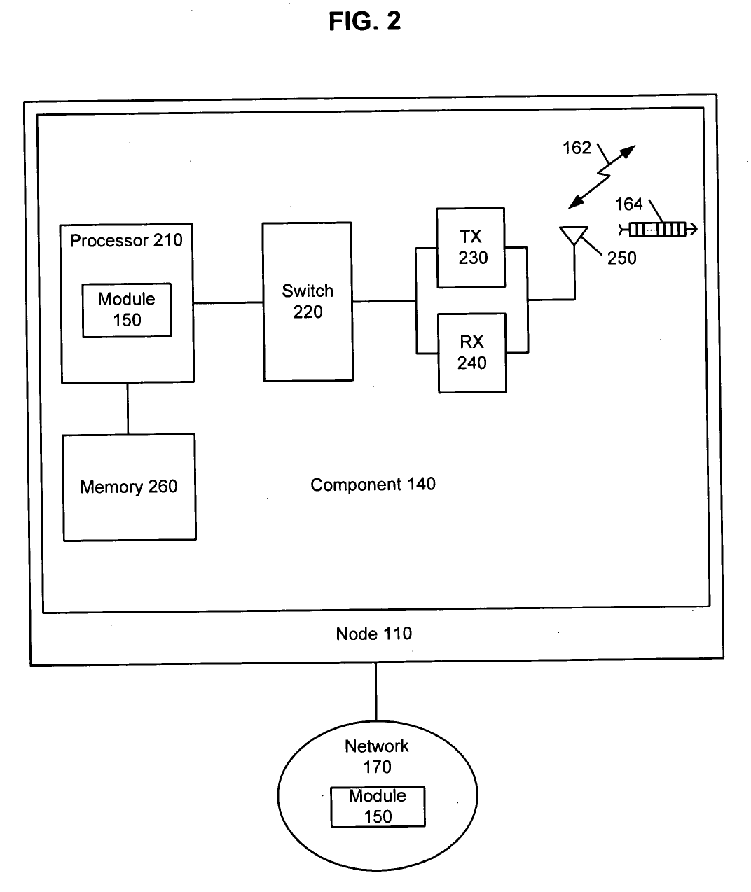

FIG. 2 more specifically illustrates node 110 of the communications system 100. As shown in FIG. 2, the node may comprise multiple elements such as component 140, module 150, processor 210, memory 260, switch 220, transmitter 230, receiver 240, and antenna 250 to communicate packets 164 over wireless shared media 160. Transmitter 230 and receiver 240 may also be collectively referred to as a transceiver. Antenna 250 may include an internal antenna, an omni-directional antenna, a monopole antenna, a dipole antenna, an end fed antenna or a circularly polarized antenna, a micro-strip antenna, a diversity antenna, a dual antenna, an antenna array, and so forth. There may further be multiple antennas (e.g., a MIMO system). Some elements may be implemented using, for example, one or more circuits, components, registers, processors, software subroutines, or any combination thereof. Although FIG. 2 shows a limited number of elements, it can be appreciated that additional or fewer elements may be used in node 110 as desired for a given implementation. The embodiments are not limited in this context.

As noted, in an embodiment, node 110 may include a processor 210. Processor 210 may be connected to switch 220 and/or the transceiver (e.g., transmitter 230 and receiver 240). Processor 210 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In an embodiment, for example, processor 210 may be implemented as a general purpose processor, such as a processor made by Intel® Corporation, Santa Clara, Calif. Processor 210 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, processor 210 may include, or have access to, memory 260. Memory 260 may comprise any machine-readable media. Memory 260 may be implemented using any machine-readable or computer-readable media capable of storing data, including both volatile and non-volatile memory. For example, memory 260 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 260 may be included on the same integrated circuit as processor 210, or alternatively some portion or all of memory 260 may be disposed on an integrated circuit or other medium, for example a hard disk drive, that is external to the integrated circuit of processor 210. The embodiments are not limited in this context.

When implemented in a node of communications system 100, node 110 may be arranged to communicate information over wireless communications media between the various nodes, such as nodes 120 and 130. The information may be communicated using in the form of packets 164 over wireless shared media 160, with each packet 164 comprising media information and/or control information. The media and/or control information may be represented using, for example, multiple Orthogonal Frequency Division Multiplexing (OFDM) symbols. A packet 164 in this context may refer to any discrete set of information, including a unit, frame, cell, segment, fragment, and so forth. The packet may be of any size suitable for a given implementation. The embodiments are not limited in this context.

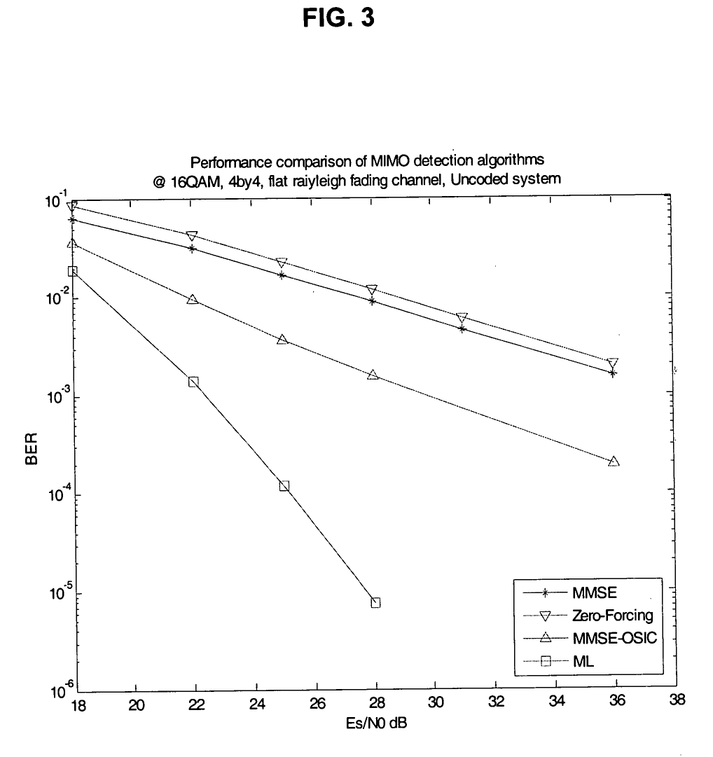

FIG. 3 through FIG. 10 more specifically describe, for example, the MIMO detection of the communications system 100 and/or node 110. For example, a linear MIMO channel can be expressed as:
Y_{N}=H_{N×M}·X_{M} (1)
M is the number of transmitter antenna, N is the number of receive antenna, X_{M} is the transmitted signal, Y_{N} is the received signal. H_{N×M} is the N×M channel state information (CSI) matrix. In an 802.11, 802.16, or 3GGP system, for example, information can be spatially transmitted from M transmit antennas, and received by N receive antennas. Channel estimation may be used to estimate the CSI. For such a system, MIMO detection module may be used to detect the originally transmitted signal X_{M} based on the received Y_{N} and estimated CSI matrix H_{N×M}. The MIMO detection algorithm processed by the MIMO detection module may be either linear or non-linear. A linear MIMO detection algorithm uses the linear equation to obtain a weight vector, and thereafter multiplies the received multiplexed signal by the weight vector to obtain the estimated transmitted signal. Current approaches for linear MIMO detection include Zero Forcing (ZF) and Minimum Mean Square Error (MMSE). The equations for ZF and MMSE detection are:
ZF: \hat{X}_{M}=W·Y_{N}=(H^{H}H)⁻¹H^{H}·Y_{N} (2)
MMSE: \hat{X}_{M}=W·Y_{N}=(H^{H}H+ρI)⁻¹H^{H}·Y_{N} (3)
In addition to the variables listed above, W is a weight matrix, H is a channel state information matrix, I is the identical matrix, and ρ is a reciprocal to a signal-to-noise ratio (SNR). Each has a computational complexity that is relatively low compared to other methods; however each may demonstrate reduced performance as a trade-off.

Non-linear MIMO detectors utilizes non-linear methods to the benefit of their performance and detriment to their computational complexity. Common non-linear MIMO detector algorithms include MMSE-Optimum SIC (for example, Vertical Bell Laboratories Layered Space Time, or V-BLAST) and Maximum Likelihood (ML). The V-BLAST method, for example, is based on MMSE or ZF and unitizes the idea of serial interference cancellation. After a V-BLAST MIMO detector detects a single data stream in a MIMO transmission, it cancels the single data stream from the received signal. Thereafter, further MIMO detection may be performed on the un-canceled portion of the received signal by the same MMSE or ZF method with smaller matrix size. The ML detection method is the optimal detection of signals over MIMO and is well-known to be an NP-complete (e.g., ML the detection is a mathematical problem that is both NP—verifiable in nondeterministic polynomial time—and NP-hard in that any NP-problem can be translated into this problem). The ML detection method brutally tries all the candidates to find the one that is most likely. The number of candidates from which the ML detection method makes its determination depends on the number of transmitter antennas and constellation size. FIG. 3 illustrates the performance of the four aforementioned MIMO detection methods. Of note is that the ML MIMO detection exhibits substantially better performance with respect to bit error rate (BER) for a given energy per symbol divided by the noise spectral density (Eₛ/N₀). In particular, at a BER of 103, the ML MIMO detection method is approximately 13.5 dB better than the MMSE method.

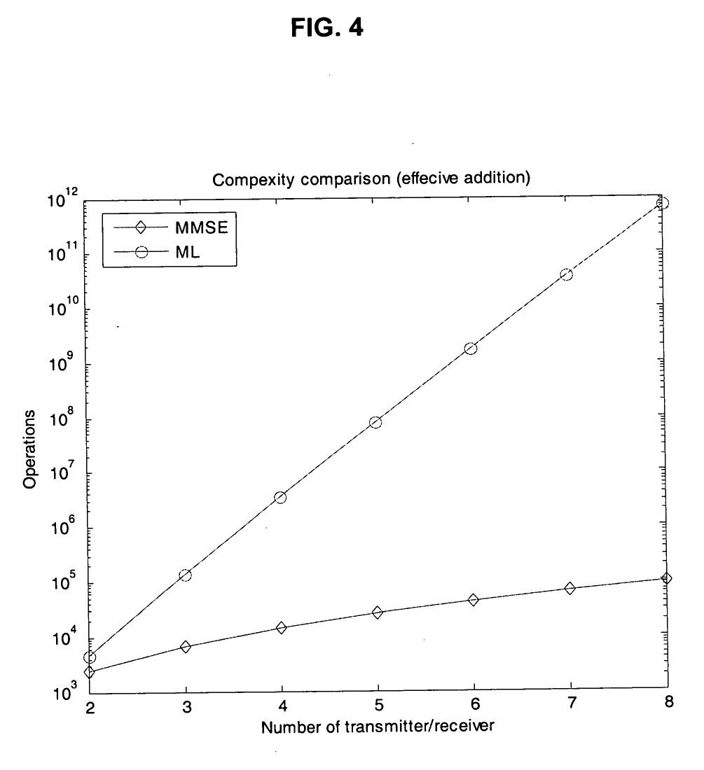

Despite the theoretical performance of the ML MIMO detection method, its complexity may limit its practicality. For example, the complexity of the ML MIMO detection method may increase exponentially depending on the number of antennas in the MIMO system and constellation size. More particularly, for BPSK (4×4), there are 16 candidates. For QPSK (4×4) there are 256 candidates. 16-QAM (4×4) has 65,536 candidates while 64-QAM (4×4) has over 1.6 million candidates. FIG. 4 illustrates a complexity comparison between ML and MMSE detection (for which effective addition is used as the metric and one multiplier equals twenty-five adders. For ML detection, multiplication by a constellation value can be treated as an addition because the constellation is fixed). As illustrated, for a 4×4 antenna system and 16-QAM, the complexity of the ML detection method is about 1000 times greater than that of the MMSE detection.

Another shortcoming of ML MIMO detection is that it is difficult to obtain soft information from the received signal with such a method. Soft information is important for wireless communication particularly given its relevance to powerful channel decoders utilizing Turbo code, LDPC code, and iterative variants or combinations of each.

As noted above, The MIMO detection method of an embodiment has performance approaching that of a maximum likelihood (ML) algorithm while having a reduced computational complexity. The method of an embodiment decomposes N×M MIMO system into a 2×2 MIMO system. It adopts both an ML tree search method and a serial interference cancellation method to operate on the decomposed 2×2 received signal matrix. Further, by adding a combing technique, the performance of an embodiment approaches the performance of ML detection while at a reduced total complexity. The equation of the method of an embodiment is as follows, where NM is the channel noise:

$$\begin{matrix}{Y}_{N \times 1} = {H}_{N \times M} {X}_{M} + {N}_{M} = [ \begin{matrix}{h}_{1 , 1} & {h}_{1 , 2} & … & {h}_{1 , M} \\ {h}_{2 , 1} & {h}_{2 , 2} & … & {h}_{2 , M} \\ ⋮ & ⋮ & ⋮ & ⋮ \\ {h}_{N , 1} & {h}_{N , 2} & … & {h}_{N , M}\end{matrix} ] [ \begin{matrix}{x}_{1} \\ {x}_{2} \\ ⋮ \\ {x}_{M}\end{matrix} ] + {N}_{M} \\ = {Q}_{N \times M} {R}_{M \times M} {X}_{M} + {N}_{N} \\ \end{matrix} \qquad ( 4 )$$

The ML detection equation for equation (4) is:

$${{X}^{̑}}_{ML} = arg {min}_{x} ‖ {Y}_{N \times 1} - {H}_{N \times M} {X}_{M} ‖ x ∈ {\vert S \vert}^{M c} \qquad ( 5 )$$

The method of an embodiment begins with a permutation process whereby the weight of each column of the matrix H is calculated:
δᵢ=∥Hᵢ∥=h_{1,i}²+h_{2,i}²+ . . . +h_{M,k}² (6)
The columns may then be reordered according to δᵢ to obtain the new channel matrix:
Ĥ₁=(H₁, H₂, H₃ . . . H_{M}) δ₁<δ₂< . . . <δ_{M} (7)

Following the permutation process is a QR decomposition process for which Q₀ is the unitary matrix, and R₀ is an up triangular matrix:
Ĥ=Q₀R₀ (8)
Q₀′ (the transpose of Q₀) may thereafter be multiplied to both sides of equation (4). For example, the received signal vector Y becomes Y′=Q₀Y, and the channel matrix Q₀′Ĥ=Q₀′Q₀R₀=R₀. The first M−1 rows of the R₀ matrix may then be reordered to obtain another K−1 matrix (total of K matrices) and Y′ may also be re-ordered to obtain the K−1 vector accordingly.
Y′ₖ k=0:K−1 (9)
Rₖ k=0:K−1 (10)
The K matrix, by a unitary transform, may be transformed to an up triangular matrix. The received vector Yₖ′ is multiplied by the unitary matrix accordingly to obtain Yₖ″. For each up triangular matrix Rₖ for which k=0, 2 . . . K−1, the last two rows may be extracted to construct a 2×2 up triangular matrix:

$${R}_{k} = [ \begin{matrix}{r}_{1 , 1} & {r}_{1 , 2} \\ 0 & {r}_{2 , 2}\end{matrix} ] \qquad ( 11 )$$

In addition, the last two rows of Yₖ″ may be extracted to obtain:

$${Y}_{k}^{″} = [ \begin{matrix}{y}_{1} \\ {y}_{2}\end{matrix} ] \qquad ( 12 )$$

For each 2×2 matrix from the QR decomposition (total of K 2×2 matrices), the following calculations may follow to estimate the first layer signal x_{M}. Mc is the size of the constellation (e.g., Mc=2 for BPSK, Mc=4 for QPSK, and Mc=16 for 16-QAM):
S_{BSK}=[−1 1] S_{QPSK}=[−1−j −1+j 1−j 1+j]/sqrt(2)
S_{16QAM}=[−3+3j −1+3j . . . 3+3j]/sqrt(10) (13)
E_{1,i}=|y₂−r_{2,2}Sᵢ|² i=1:Mc (14)
E_{2,i,j}=|y₁−r_{1,1}·Sⱼ−r_{1,2}S₁|²+E_{1,i} i,j=1:Mc (15)
Thereafter, for each constellation point, a metric may be calculated:
Metricᵢ^{k}=min(E_{2,i,j}) i,j=1:Mc, k=0:K (16)
Equation (16) determines the minimum value of E_{2,i,j} over j given i. For example, if Mc=16 (e.g., for 16-QAM), 16 metrics may be obtained: Metricᵢ^{k} i=1:16.

The ML detection may thereafter be followed by a combining process by which the metrics calculated in the ML detection are combined. In general, the metrics may be combined by the following equation:
Mᵢ=f(Metricᵢ⁰,Metricᵢ¹, . . . , Metricₖ^{K-1}) (17)
For example, the combination function may be an equal gain function such that:
Mᵢ=Metricᵢ⁰+Metricᵢ¹+, . . . , +Metricᵢ^{K-1} i=1: Mc (18)
It is to be understood that another metric combination function may also be used for example a maximum ratio combination (MRC).

In an embodiment following the combining process of equations (17) and (18) for example, is a soft demodulation process:
LLR(b)=f(M_{b,-1},M_{b,1})=M_{b,-1}−M_{b,1} or \sqrt{M_{b,-1}}−\sqrt{M_{b,1}} (19)
where b=1: log₂(Mc)
   M_{b,-1}=min(Mₖ) (20)
   where kε1: Mc and Sₖ is one point of the constellation that makes the bits b equal to “−1” and
   M_{b,1}=min(Mₖ) (21)
   where kε1:Mc and Sₖ is one point of the constellation that makes the bits b equal to “1.” In an embodiment, the soft output log likelihood ratio (LLR) for each bit may then be output to a channel decoder.

A hard decision estimation of \hat{x}_{M} may be then be performed in an embodiment:

$${{x}^{̑}}_{M} = {arg min}_{i} ( {M}_{i} ) \\ i = 1 \text{:} M c \qquad ( 22 )$$

Thereafter, \hat{x}_{M} may be canceled from the received vector Y′ where R₀(:,M) is the last column of R₀:
Y₁=Y′−\hat{x}·R₀(:,M) (23)
Equation (22) thereby obtains the new vector Y=Y₁(0:M−1), and new triangular matrix R₀=R₀(0:M−1:,0:M−1). The same method may be repeated to determine other symbols with new Y and R₀, M=M−1.

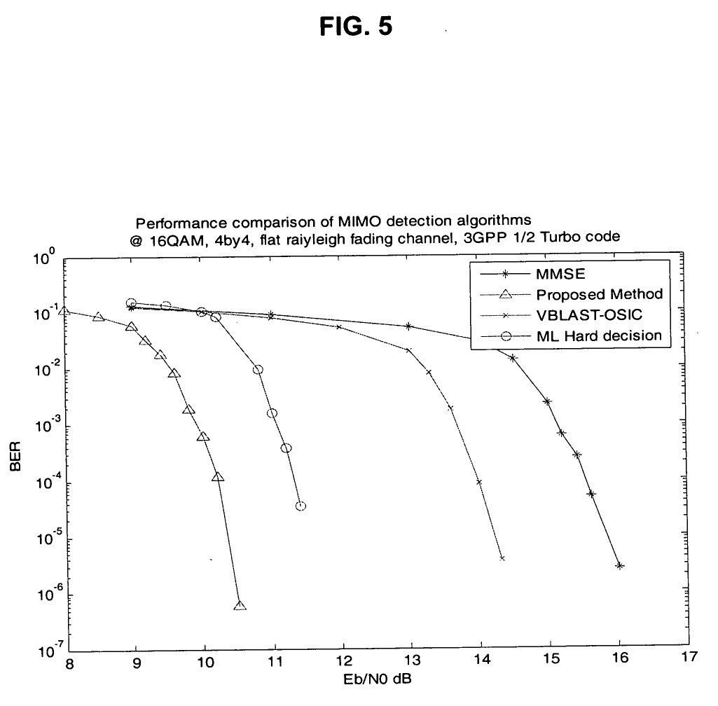

FIG. 5 illustrates the performance of soft quasi-ML MIMO detection method of an embodiment including a 4×4 antenna, 16-QAM, flat fading channel, ½ 3GPP turbo code, code length 5112. The method of an embodiment, when compared to MMSE, VBLAST-OSIC, and ML hard decision detection algorithms, exhibits favorable performance. In particular, at a 10⁻³ BER, the method of an embodiment has approximately a 1.3 dB improvement over the ML hard decision algorithm.

For a 4×4 antenna, 16-QAM configuration, the method of an embodiment performs ML MIMO detection on six 6, 2×2 matrices representing the received signal utilizing 6×256, or 1,536 candidates. By comparison, brutal ML MIMO detection utilizes 65,535 candidates. Accordingly, the method of an alternate embodiment utilizes approximately only 2% of the candidates as the brutal ML MIMO detection. Further, in terms of additions and multipliers, for each candidate, one 2×2 matrix is only ¼ of a 4×4 matrix. Accordingly the complexity of the method of an embodiment may be below 1% of that of brutal ML MIMO detection. Further, the performance of the method of an embodiment is only approximately 1.3 dB less than the brutal ML MIMO detection at a BER of 10⁻³.

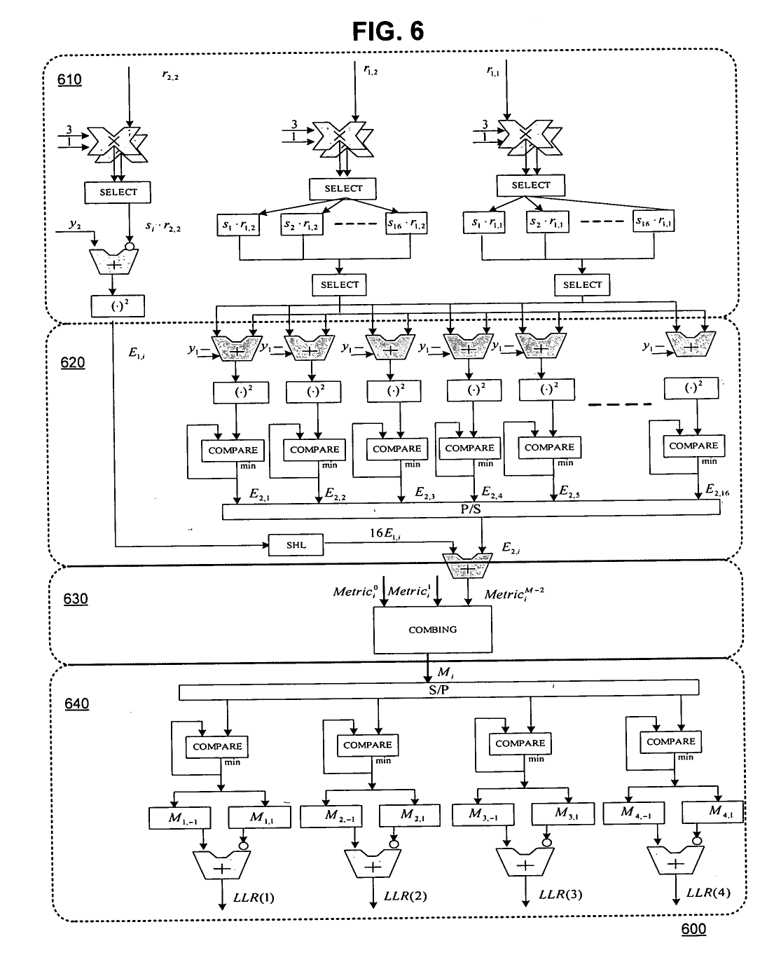

FIG. 6 illustrates a block diagram of a portion of a MIMO detector 600 of an embodiment. In particular, FIG. 6 illustrates a block diagram of a 2×2 ML detection and LLR soft output for a 16-QAM received signal. As noted, the ML detection may operate on multiple 2×2 matrices decomposed (e.g., with QR decomposition) from a larger (e.g., 4×4) received MIMO signal. For example, block 610 may perform the function of equation 8 of an embodiment. Block 620 may then perform the function of equations 13-15 to calculate the ML metrics of an embodiment. Thereafter the metrics may be combined according to equation 18 by block 630. Block 640 may then, according to equations 19-20, calculate the LLR soft output. The LLR soft output may then be decoded according to any decoding or iterative decoding algorithm that may benefit from a soft output.

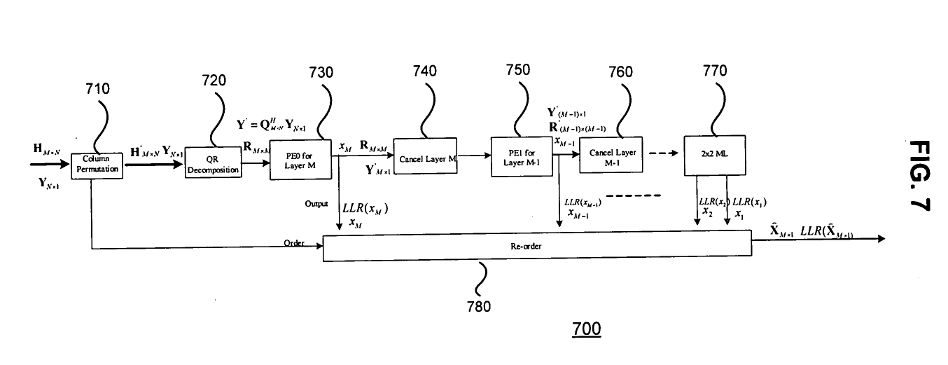

FIG. 7 illustrates a block diagram of a portion of a MIMO detector 700 of an embodiment. For example, the received MIMO signal first undergoes column permutation according to equation 7 at block 710. The output from block 710 then undergoes QR decomposition according to equation 8 at block 720. The output from block 720 (e.g., process element) undergoes the 2×2 maximum likelihood detection of equations (13-16). Thereafter, at 740, layer M is canceled and the same process element as block 720 is performed on the output for layer M−1 at block 750. Layer M−1 is canceled at block 760 and so on until what remains is a 2×2 matrix that can undergo maximum likelihood processing according to equations (13-16). Further, in an embodiment, the soft output from each process element may be output to block 780 where it is reordered. Thereafter, the output from the reorder block 780 may then be decoded according to any decoding algorithm or any iterative decoding algorithm that may further benefit from a soft output.

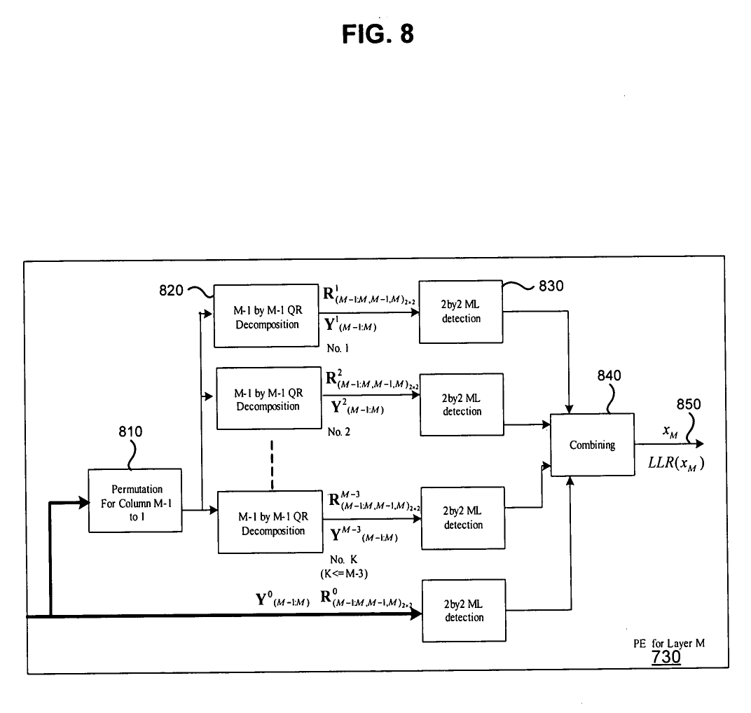

FIG. 8 illustrates detail of the block diagram of FIG. 7. In particular, FIG. 8 illustrates the process element (e.g., PE 730 and PE 750 of FIG. 7) for layer M of the received signal. At block 810, the permutation (e.g., weighting of equation (6) and reordering of equation (7) may be performed on the received signal for columns M−1 to 1. Thereafter, at block 820 the (M−1)×(M−1) resulting matrix may undergo QR decomposition K times, for which K<(M−3). The result of each of K blocks 820 is a 2×2 matrix that may undergo maximum likelihood detection, the outputs of which are combined at block 840. The output 850 of block 840 may, for example, be reordered at block 780 of FIG. 7 with the similar combined output of other received signal layers as explained with reference to FIG. 7.

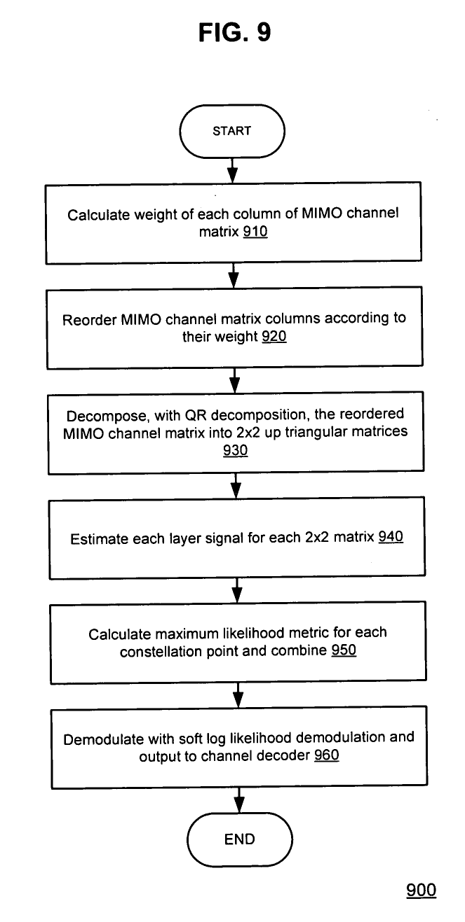

FIG. 9 illustrates a logic flow 900 of an embodiment. At 910, the weight of each column of a MIMO channel matrix is calculated. At 920, the columns of the MIMO channel matrix are reordered according to their weight. In an embodiment, the columns are reordered in ascending order according to their weight. At 930, the reordered MIMO channel matrix is decomposed into 2×2 matrices. In an embodiment, the MIMO channel matrix is decomposed with a QR decomposition process into up triangular 2×2 matrices. Thereafter, at 940 a first layer signal is estimated for each 2×2 matrix and 940 is repeated for each additional signal layer. At 950, a maximum likelihood metric is calculated for each constellation point of each 2×2 matrix, and the metrics for each 2×2 matrix are combined. In an embodiment, the maximum likelihood metrics are combined with an equal gain function or maximum ratio function for each 2×2 matrix. Thereafter, at 960 the combined maximum likelihood metrics for each 2×2 matrix are demodulated and outputted to a channel decoder. In an embodiment, the demodulation is a soft output log likelihood demodulation. The channel decoder may then decode the output according to any decoding method to recover, for example, a signal or signals from the MIMO channel.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, such as the examples given with reference to FIG. 2. For example, the memory unit may include any memory device, memory article, memory medium, storage device, storage article, storage medium and/or storage unit, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

What is claimed is:

1. An apparatus comprising:
a node to
calculate a weight of each column of a MIMO channel matrix;
reorder the MIMO channel matrix columns according to their weight; and
decompose, with QR decomposition, the reordered MIMO channel matrix into a plurality of 2×2 up triangular matrices.

2. The apparatus of claim 1, the node to further:
estimate each layer signal for each up triangular 2×2 matrix.

3. The apparatus of claim 2, the node to further:
calculate a maximum likelihood metric for each constellation point of each up triangular 2×2 matrix.

4. The apparatus of claim 3, the node to further:
combine the maximum likelihood metrics for each up triangular 2×2 matrix.

5. The apparatus of claim 4, the node to further
demodulate, with soft log likelihood demodulation, the combined maximum likelihood metrics; and
output the demodulated combined maximum likelihood metrics to a channel decoder.

6. A communications system comprising:
a plurality of antennas; and
a node coupled to the antennas, the node to
calculate a weight of each column of a MIMO channel matrix;
reorder the MIMO channel matrix columns according to their weight; and
decompose, with QR decomposition, the reordered MIMO channel matrix into a plurality of 2×2 up triangular matrices.

7. The communications system of claim 6, the node to further:
estimate each layer signal for each up triangular 2×2 matrix.

8. The communications system of claim 7, the node to further:
calculate a maximum likelihood metric for each constellation point of each up triangular 2×2 matrix.

9. The communications system of claim 8, the node to further:
combine the maximum likelihood metrics for each up triangular 2×2 matrix.

10. The communications system of claim 9, the node to further:
demodulate, with soft log likelihood demodulation, the combined maximum likelihood metrics; and
output the demodulated combined maximum likelihood metrics to a channel decoder.

11. A method comprising:
calculating a weight of each column of a MIMO channel matrix;
reordering the MIMO channel matrix columns according to their weight; and
decomposing the reordered MIMO channel matrix into a plurality of 2×2 up triangular matrices.

12. The method of claim 11 further comprising:
estimating each layer signal for each up triangular 2×2 matrix.

13. The method of claim 12 further comprising:
calculating a maximum likelihood metric for each constellation point of each up triangular 2×2 matrix.

14. The method of claim 13 further comprising:
combining the maximum likelihood metrics for each up triangular 2×2 matrix.

15. The method of claim 14 further comprising:
demodulating the combined maximum likelihood metrics; and
outputting the demodulated combined maximum likelihood metrics to a channel decoder.

16. An article comprising a machine-readable storage medium containing instructions that if executed enable a communications system to:
calculate a weight of each column of a MIMO channel matrix;
reorder the MIMO channel matrix columns according to their weight; and
decompose the reordered MIMO channel matrix into a plurality of 2×2 up triangular matrices.

17. The article of claim 16 further comprising instructions that if executed enable the communications system to:
estimate each layer signal for each up triangular 2×2 matrix.

18. The article of claim 17 further comprising instructions that if executed enable the communications system to:
calculate a maximum likelihood metric for each constellation point of each up triangular 2×2 matrix.

19. The article of claim 18 further comprising instructions that if executed enable the communications system to:
combine the maximum likelihood metrics for each up triangular 2×2 matrix.

20. The article of claim 19 further comprising instructions that if executed enable the communications system to:
demodulate the combined maximum likelihood metrics; and
output the demodulated combined maximum likelihood metrics to a channel decoder.
